(19) United States
(12) Patent Application Publication
(10) Pub. No.: US 2010/0098614 A1
(43) Pub. Date: Apr. 22, 2010

(54) PROCESS FOR SYNTHESIS OF CLAY PARTICLES

(75) Inventor: Mahesh Dahyabhai Patel, Singapore (SG)

Correspondence Address: OSHA LIANG L.L.P., TWO HOUSTON CENTER, 909 FANNIN, SUITE 3500, HOUSTON, TX, 77010, US

(73) Assignee: SHAYONANO SINGAPORE PTE LTD, Singapore (SG)

(21) Appl. No.: 12/531,420

(22) PCT Filed: Mar. 14, 2008
(86) PCT No.: PCT/SG2008/000080

§ 371 Date: Sep. 15, 2009

Related U.S. Application Data
(60) Provisional application No. 60/895,317, filed on Mar. 16, 2007.

(51) Int. Cl. C01B 33/40; C01F 7/50; C01B 33/26; C01B 33/24

(52) U.S. Cl. 423/328.1; 423/465; 423/327.1; 423/331

(57) ABSTRACT

A process for synthesizing clay particles comprising the step of heating a reactant solution mixture of metal salt and a metal silicate using a radiation source under conditions to form said synthetic clay particles.

### TECHNICAL FIELD

The present invention generally relates to a process for synthesizing clay particles.

### BACKGROUND

Clays generally refer to a highly variable group of natural materials that are soft, earthy, extremely fine grained, usually plastic when moist and consisting of one or a mixture of various clay minerals and impurities. Alkaline metals such as sodium, lithium and potassium and alkaline earth metals such as magnesium, calcium and barium are often present in the molecular structure of clays and have a significant effect in their physical and chemical properties.

Clays play a very important role in many industries. Their use depends upon their physical and chemical properties. Some of these uses include manufacturing of face bricks, chimney flue linings, sewer pipes, stoneware and earthenware pottery, fire bricks, production of aluminum, kaolin fibres, porcelain, as a component in portland cement, synthetic zeolites, wall and floor tiles, rubber, as a filler for paper, paint, adhesives, sealants, extender, whitening, caulking, reinforcing agent and production of lightweight aggregate as a substitute for gravel in concrete products

However, large quantities of natural clays are not readily available and are usually mixed with impurities. The removal of these impurities from the clays can be extremely difficult. It is therefore desirable to be able to synthesize synthetic clay particles that are in a substantially pure state and which have desirable rheological properties similar to, or better than, naturally occurring clays.

One of the known processes for synthesizing synthetic clay particles involves a straightforward co-precipitation step with an alkali and fluoride ion and subsequent hydrothermal treatment which involves convectional heating with agitation under reflux at atmospheric pressure and in some cases with high temperature and high pressure. However, the hydrothermal treatment step usually requires a time period of at least 10 to 20 hours. This is because the process time for conventional heating to take place is limited by the rate of heat flow into the body of the material from the surface as determined by its mass in addition to its specific heat, thermal conductivity, density and viscosity. Convectional heating therefore suffers from the disadvantage of being a slow process.

Furthermore, the high pressures results in the need for specialized equipments such as pressure vessels, which increase the capital and operating costs associated with industrial scale plants to synthesize the clay particles.

Another disadvantage of convectional heating is non-uniform because the surfaces, edges and corners of the particles being heated are much hotter than the inside of the material.

There is a need to provide a process for synthesizing clay particles that overcomes, or at least ameliorates, one or more of the disadvantages described above.

### SUMMARY

According to a first aspect, there is provided, a process for synthesizing clay particles comprising the step of heating a reactant solution mixture of metal salt and a metal silicate using a radiation source under conditions to form said synthetic clay particles.

Advantageously, in one embodiment, the heating step is undertaken without convectional heating.

Advantageously, in one embodiment, the heating step is undertaken without conductive heating.

Advantageously, in one embodiment, the heating step is undertaken using a microwave heating source.

Advantageously, the use of a radiation source provides an energy efficient synthesis process for synthesizing clay particles as lesser time may be required for co-precipitation of the synthetic clay particles from the solution mixture.

Advantageously, the use of a radiation source also allows better control of the size and shape and uniformity in composition of the particles being synthesized.

According to a second aspect of the invention, there is provided a clay particle made in a process according to the first aspect.

### DEFINITIONS

The following words and terms used herein shall have the meaning indicated:

The term “synthetic clay” is to be interpreted broadly to include materials related in structure to layered clays and porous fibrous clays such as synthetic hectorite (lithium magnesium sodium silicate). It will be appreciated that within the scope of the invention the following classes of clays have application alone or in combination and in mixed layer clays: kaolinites, serpentines, pyrophyllites, talc, micas and brittle micas, chlorites, smectites and vermiculites, palygorskites and sepiolites. Other phyllosilicates (clay minerals) which may be employed in the tablets according to the invention are allophane and imogolite. The following references describe the characterisation of clays of the above types: Chemistry of Clay and Clay Minerals. Edited by A. C. D. Newman. Mineralogical Society Monograph No. 6, 1987, Chapter 1; S. N. Bailey; Summary of recommendations of AIPEA Nomenclature Committee, Clay Minerals 15, 85-93; and A Handbook of Determinative Methods in Mineralogy, 1987, Chapter 1 by P. L. Hall.

The term “radiation source” is to be interpreted broadly to include any electromagnetic waves that are capable of heating an aqueous solution.

The term “metal silicate” is to be interpreted broadly to include any compounds having a metal cation forming a bond with a silicate anion.

The term “silicate” is to be interpreted broadly to include any anion in which one or more central silicon atoms are surrounded by electronegative ligands such as oxygen.

The word “substantially” does not exclude “completely” e.g. a composition which is “substantially free” from Y may be completely free from Y. Where . necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

### DISCLOSURE OF OPTIONAL EMBODIMENTS

Exemplary, non-limiting embodiments of a process for synthesizing synthetic clay particles will now be disclosed.

The metal silicate may be any alkali metal silicate or alkaline earth metal silicate or blend thereof. Exemplary metal silicates include lithium silicate, sodium silicate, potassium silicate, beryllium silicate, magnesium silicate and calcium silicate.

In one embodiment, the reactant solution mixture comprises a molar excess of the metal silicate relative to the metal salt.

Advantageously, heating using a radiation source allows heating of a material at substantially the same rate throughout its volume, that is, it enables volumetric heating. Heat energy from the radiation source is transferred through the heated material electro-magnetically. Consequently, the rate of heating is not limited by the rate of heat transfer through a material as during convectional or conductive heating, and the uniformity of heat distribution is greatly improved. Heating times may be reduced to less than one percent of that required using convectional or conductive heating.

Exemplary radiation sources include radio waves, microwaves, infrared, ultraviolet, X-rays and gamma rays. In one embodiment, the radiation source is a microwave radiation source. The two main mechanisms of microwave heating are dipolar polarization and conduction mechanism. Dipolar polarization is a process by which heat is generated in polar molecules. When an electromagnetic field is applied, the oscillating nature of the electromagnetic field results in the movement of the polar molecules as they try to align in phase with the field. However, the inter-molecular forces experienced by the polar molecules effectively prevent such alignment, resulting in the random movement of the polar molecules and generating heat. Conduction mechanisms result in the generation of heat due to resistance to an electric current. The oscillating nature of the electromagnetic field causes oscillation of the electrons or ions in a conductor such that an electric current is generated. The internal resistance faced by the electric current results in the generation of heat. Accordingly, the microwaves may be used to produce high temperatures uniformly inside a material as compared to conventional heating means which may result in heating only the external surfaces of a material.

The microwaves may be applied at a power in the range selected from the group consisting of about 30 W to about 180 KW, about 30 W to about 150 KW, about 30 W to about 120 KW, about 30 W to about 100 KW, about 30 W to about 50 KW, about 30 W to about 25 KW, about 30 W to about 15 KW, about 30 W to about 10 KW, about 30 W to about 5 KW, about 30 W to about 2 KW, about 30 W to about 1200 W, about 50 W to about 1200 W, about 100 W to about 1200 W, about 200 W to about 1200 W, about 300 W to about 1200 W, about 400 W to about 1200 W, about 500 W to about 1200 W, about 600 W to about 1200 W, about 700 W to about 1200 W, about 800 W to about 1200 W, about 900 W to about 1200 W, about 1000 W to about 1200 W, about 30 W to about 1100 W, about 30 W to about 100 W, about 30 W to about 80 W, about 30 W to about 60 W, about 30 W to about 40 W, about 40 W to about 120 W, about 60 W to about 120 W, about 80 W to about 120 W, about 100 W to about 120 W, about 70 W to about 100 W and about 50 W to about 70 W.

Typical frequencies of microwaves may be in the range of about 300 MHz to about 300 GHz. This range may be divided into the ultra-high frequency range of 0.3 to 3 GHz, the super high frequency range of 3 to 30 GHz and the extremely high frequency range of 30 to 300 GHz. Common sources of microwaves are microwave ovens that emit microwave radiation at a frequency of about 0.915, 2.45, or 5.8 GHz. The microwaves may be applied with a frequency in the range selected from the group consisting of about 0.3 GHz to about 300 GHz, about 0.3 GHz to about 200 GHz, about 0.3 GHz to about 100 GHz, about 0.3 GHz to about 50 GHz, about 0.3 GHz to about 10 GHz, about 0.3 GHz to about 5.8 GHz, about 0.3 GHz to about 2.45 GHz, about 0.3 GHz to about 0.915 GHz and about 0.3 GHz to about 0.9 GHz.

In one embodiment, the microwave heating is conducted for a period of time in the range of about 10 minutes to 2 hours.

The heating process may be undertaken under substantially alkaline pH conditions. In one embodiment, the pH is in the range of at least 8.5. Advantageously, the pH is in the range of 9 to 10. This is to provide an optimum environment for the co-precipiation of the clay particles from the reactant mixture. In one embodiment, a metal hydroxide solution is added to the reactant solution mixture to obtain said alkaline pH condition.

The metal of the metal salt may be a multi-valent metal. This metal may be selected from the group consisting of alkali metals, alkaline earth metals, a metals of group IIIA, VIIA and VIII of the Periodic Table of Elements. Exemplary metal include sodium, potassium, lithium, magnesium, calcium, aluminium, iron, and manganese.

The anion of the metal salt may be a halide. Exemplary anion include chloride and fluoride.

The metal salt and metal silicates may be selected to synthesize the clay particles selected from the group consisting of chryolite, chlinochlore, kaolinite, nontronite, paragonite, phlogopite, pyrophyllite, smectite, talc, vermiculaite and mixtures thereof. Exemplary smectite clay include bentonite, beidellite, hectorite, montmorillonite, saponite, stevensite, and mixtures thereof.

The process may further comprise a step for removing of the clay particles from the reactant solution mixture. The removed clay particles may then be dried to substantially remove extraneous water therefrom. In one embodiment, the drying is carried out at a temperature of about 250 degree C. for about 8 hours.

The particle size of the clay particles may be in the nano-meter range to the micrometer range. In one embodiment, the mean size of the clay particles ranges from about 20 nm to 120 nm.

### BRIEF DESCRIPTION OF DRAWINGS

The accompanying drawings illustrate a disclosed embodiment and serve to explain the principles of the disclosed embodiment. It is to be understood, however, that the drawings are designed for purposes of illustration only, and not as a definition of the limits of the invention.

FIG. 1 is a schematic diagram of process for mixing of the reactants to form a reactant solution mixture and a microwave oven for irradiating microwaves for co-precipitation of synthetic clay particles from the reactant solution mixture therein.

FIG. 2 is a process flow chart for synthesizing clay particles.

FIG. 3 is an X-ray diffraction pattern of the experimental sample obtained in Example 2 in comparison with Laponite® (Southern Clay Particles, Inc., Tex.).

FIG. 4 is an X-ray diffraction pattern of the experimental sample obtained in Example 3 in comparison with Laponite® (Southern Clay Particles, Inc., Tex.).

FIG. 5 is an X-ray diffraction pattern of the experimental sample obtained in Example 4 in comparison with Laponite® (Southern Clay Particles, Inc., Tex.).

FIG. 6 is an X-ray diffraction pattern of the experimental sample obtained in Example 5 in comparison with Laponite® (Southern Clay Particles, Inc., Tex.).

### DETAILED DISCLOSURE OF EMBODIMENTS

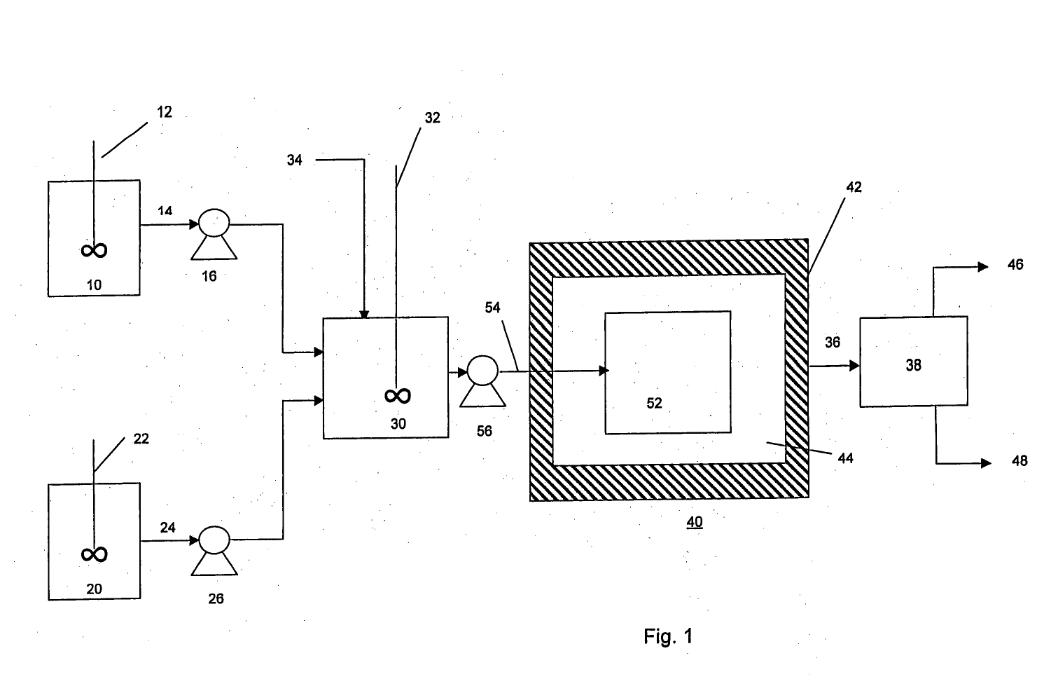

Referring to FIG. 1 there are shown two tanks (10,20) with mixers (12,22) respectively disposed therein for mixing the solutions respectively contained therein. Tank contains a metal salt solution which is mixed homogeneously therein by means of the mixer 12. Simultaneously, a metal silicate solution is homogeneously mixed in tank 20 by means of the mixer 22. The metal salt solution stream 14 and metal silicate solution stream 24 respectively obtained from the two tanks (10,20) are pumped into the reaction tank 30 using the respective pumps (16,26) as shown.

The reaction tank 30 comprises a mixer 32 to enable homogeneous mixing of the reactants obtained from the metal salt solution stream 14 and the metal silicate solution stream 24. The reaction tank 30 also comprises an alkaline feed stream 34 which allows the addition of an alkali such as sodium hydroxide to the solution contained therein, thereby raising the pH to alkaline conditions.

The reactant solution mixture hence obtained from the reaction tank 30 is pumped via a pump 56 through a stream 54 into a tank 52. The tank 52 is made of a material that is able to withstand microwave radiation without undergoing any physical or chemical changes. The tank 52 is contained within a microwave oven 40 used as a radiation source for radiating microwaves to heat up the reactant solution mixture contained in the tank 52.

The microwave oven 40 comprises a wall 42 that is impermeable to the radiation or microwaves that are produced therein. The tank 52 containing the reactant solution mixture therein is placed in the controlled environment 44 of the microwave oven 40, and exposed to the microwave radiation generated therein. The microwave radiation in the controlled environment 44 is a microwave field emitted at a frequency of about 0.3 GHz to 300 GHz with a power of 30 W to 180 kW.

The energy released by the microwave field initiates and promotes a chemical reaction between the reactants in the reactant solution mixture contained in the tank 52. This results in the co-precipitation of the synthetic clay particles from the reactant solution mixture. The mixture of synthetic clay particles and solvent hence obtained therein then passes through the product mixture stream 36 into a filter tank 38.

The product mixture is washed and filtered in the filter tank 38 to obtain a filtrate 46, that is, the solvent, and a residue 48, that is, the synthetic clay particles.

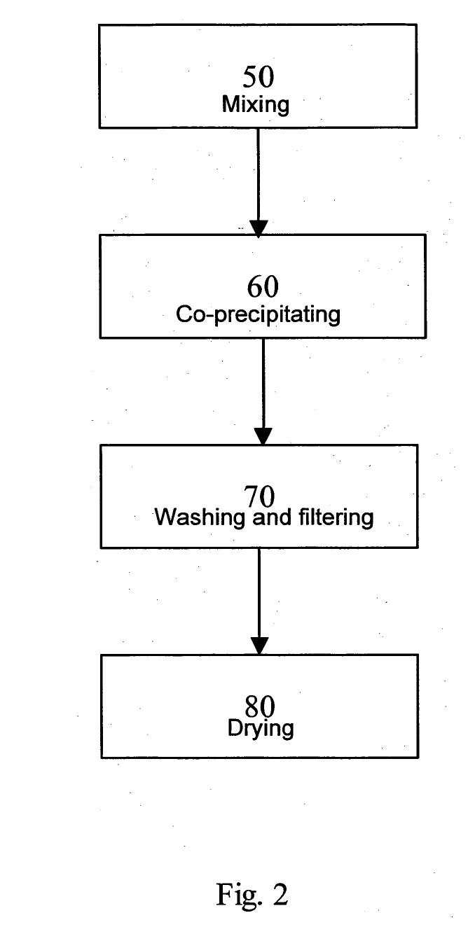

FIG. 2 shows a process flow diagram for the synthesis synthetic clay particles. The synthesis process generally comprises the step of mixing 50 the reactants (metal salt and, metal silicate solutions) to form a reactant solution mixture under the condition of an alkaline pH. The reactant solution mixture is then placed in a microwave oven to allow for co-precipitating 60 of the synthetic clay particles from the reactant solution mixture. Washing and filtering 70 steps further process a product mixture hence obtained from the co-precipitation 60 step. The filtered product is then put for drying 80 at 250 degree C. for 8 hours. Dried synthetic clay particles in a substantially pure state are then obtained.

### EXAMPLES

A non-limiting example of the invention will be further described, which should not be construed as in any way limiting the scope of the invention.

### Example 1

A first tank was loaded with 69 g of magnesium chloride (99% purity), 2.12 g of lithium chloride (99% purity) and 500 ml of water. The 88 gm Solution of Sodium Silicate (29 g Si₂O and 8.9 g Na₂O per 100 gm) is diluted in 500 ml of water. The reaction solutions are respectively homogenously mixed in the first and second tanks before being transferred into a reaction tank over a period of 30 minutes with constant stirring. 0.11 M sodium hydroxide is then added drop-wise to raise the pH of the reactant solution mixture in the reaction tank 9.5. The reactant solution mixture in the reaction tank is agitated for 30 minutes. The reaction tank is contained within a microwave oven with a power up to 1000 W, emitting microwave radiation at a frequency of 2.45 GHz for 30 minutes. The product mixture is washed with water and filtered; The filtered product is dried at 250° C. for 8 hour. Analysis of the precipitate indicated that the precipitate particles were synthetic clay and had an average particle size of about 30 nm. This indicates that microwave heating without any convectional heating is a viable means by which to synthesize clay particles.

### Example 2

A first tank was loaded with 49.94 g of magnesium chloride (99% purity), 4.45 g of lithium chloride (99% purity) and 900 ml of water. The 166 gm Solution of Sodium Silicate (29 g Si₂O and 8.9 g Na₂O per 100 gm) is diluted in 900 ml of water. The reaction solutions are respectively homogenously mixed in the first and second tanks before being transferred into a reaction tank over a period of 30 minutes with constant stirring. 0.11 M sodium hydroxide is then added drop-wise to raise the pH of the reactant solution mixture in the reaction tank to 9.5. The reaction tank is contained within a microwave oven with a power up to 5000 W operating with a frequency of 2.45 GHz. The reaction tank is then subjected to microwave radiation at a power of 1100 W for 10 minutes followed by at a power of 330 W for 50 minutes. The product mixture is washed with water and filtered. The filtered product is dried at 250° C. for 8 hours.

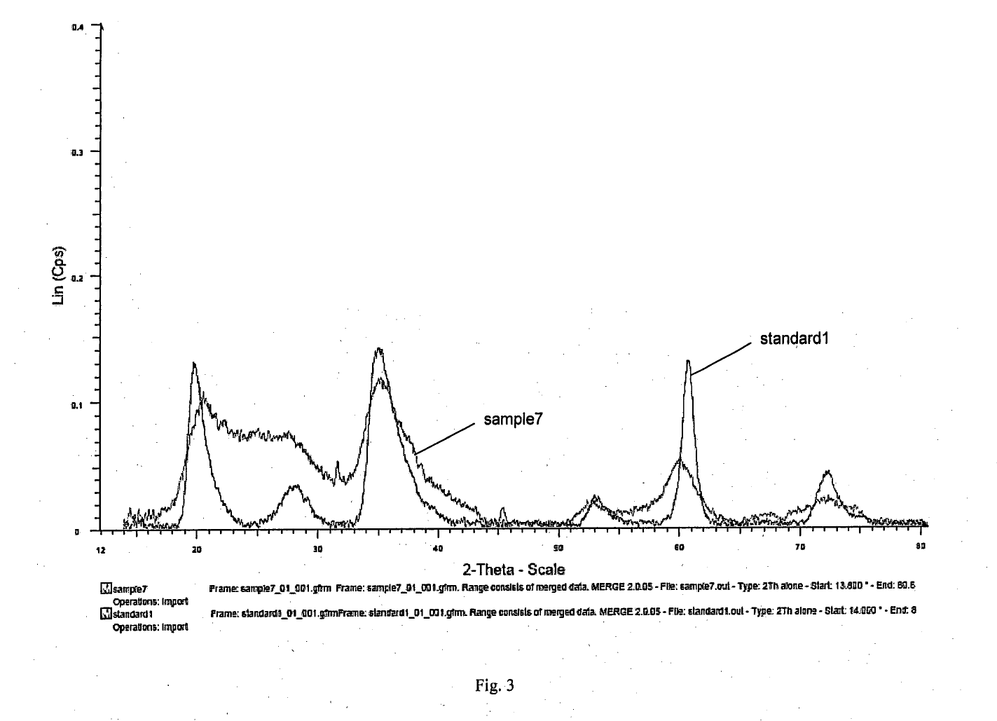

FIG. 3 shows the X-ray diffraction pattern of the experimental product (labeled as “sample7”) obtained in accordance with the experimental protocol described above in comparison with a commercially available product, Laponite® (Southern Clay Particles, Inc., Tex.) (labeled as “standard1”). As shown in FIG. 3, the X-ray diffraction pattern of the experimental product obtained is similar to that of Laponite®. Accordingly, it has been shown that the three dimensional atomic structure of the experimental product (synthetic clay particles) obtained in accordance with the disclosure herein is comparable to commercially available products.

### Example 3

The experiment is repeated in accordance with the steps in Example 2 up to the step of adjustment of the pH of the reactant solution mixture in the reaction tank to 9.5. In this Example, the reaction tank is then subjected to microwave radiation at a power of 3800 W for 10 minutes followed by at a power of 1100 W for 30 minutes. The product mixture is washed with water and filtered. The filtered product is dried at 250° C. for 8 hours.

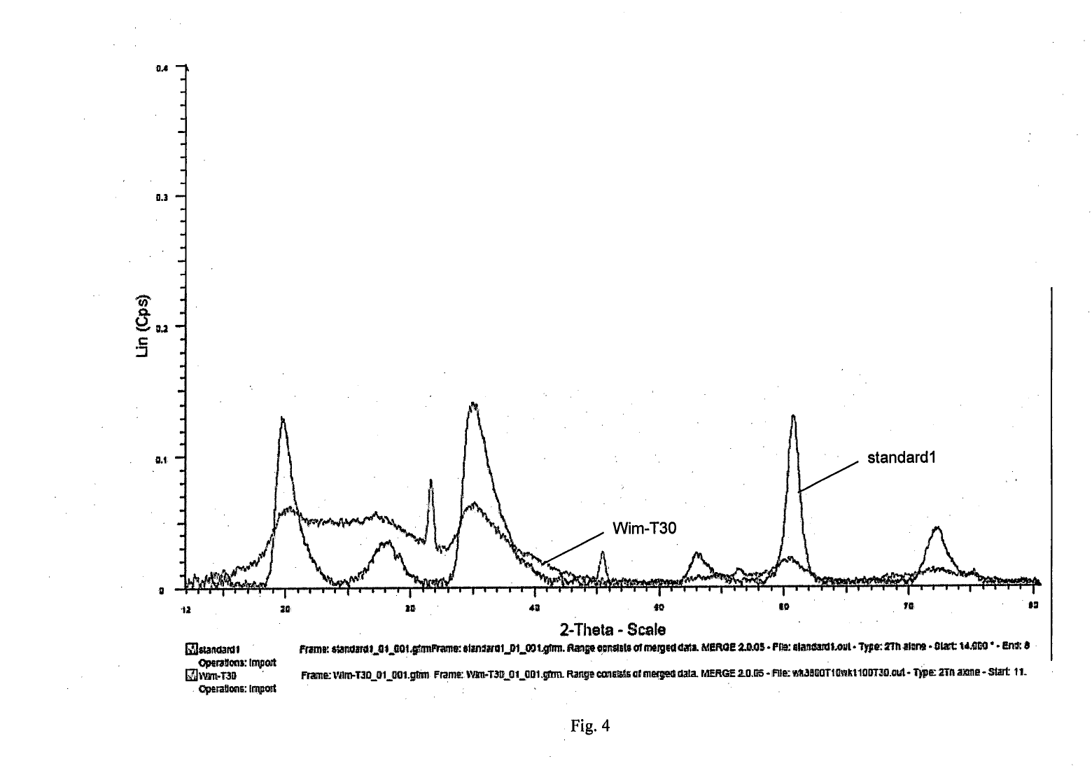

FIG. 4 shows the X-ray diffraction pattern of the experimental product (labeled as “Wim-T30”) obtained in accordance with the experimental protocol described above in comparison with a commercially available product, Laponite® (Southern Clay Particles, Inc., Tex.) (labeled as “standard1”). As shown in FIG. 4, the X-ray diffraction pattern of the experimental product obtained is similar to that of Laponite®. Accordingly, it has been shown that the three dimensional atomic structure of the experimental product (synthetic clay particles) obtained in accordance with the disclosure herein is comparable to commercially available products.

### Example 4

The experiment is repeated in accordance with the steps in Example 2 up to the step of adjustment of the pH of the reactant solution mixture in the reaction tank to 9.5. In this Example, the reaction tank is then subjected to microwave radiation at a power of 1100 W for 10 minutes followed by at a power of 800 W for 4 minutes. The product mixture is washed with water and filtered. The filtered product is dried at 250° C. for 8 hours.

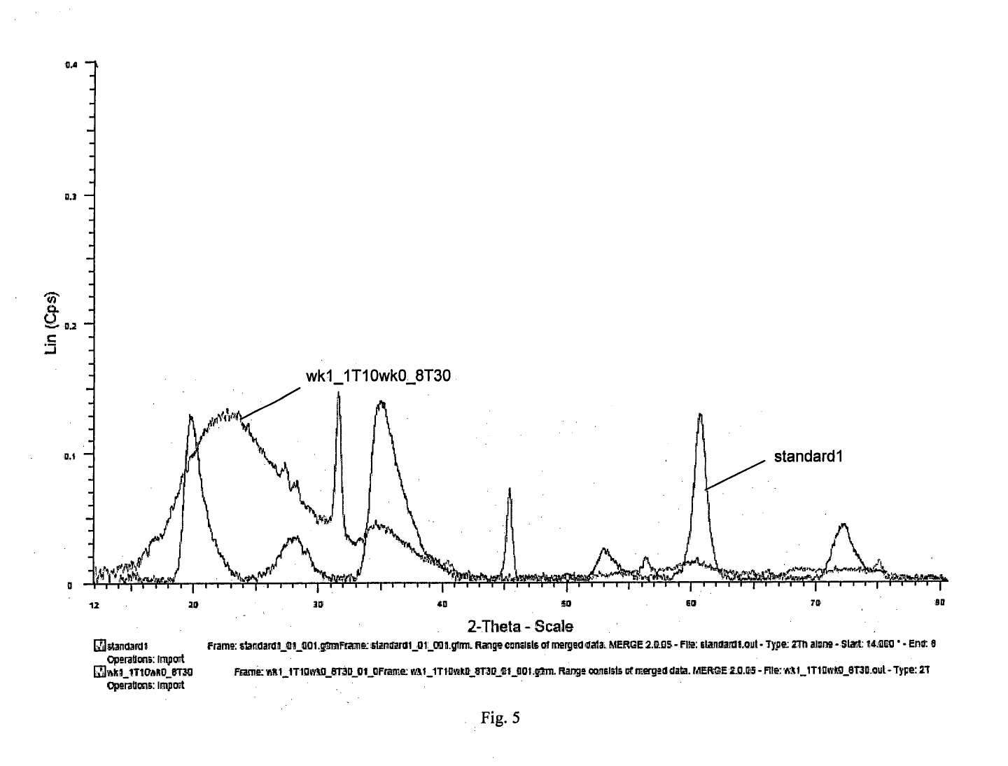

FIG. 5 shows the X-ray diffraction pattern of the experimental product (labeled as “wk1_1T10wk0_8T30”) obtained in accordance with the experimental protocol described above in comparison with a commercially available product, Laponite® (Southern Clay Particles, Inc., Tex.) (labeled as “standard1”). As shown in FIG. 5, the X-ray diffraction pattern of the experimental product obtained is similar to that of Laponite®. Accordingly, it has been shown that the three dimensional atomic structure of the experimental product (synthetic clay particles) obtained in accordance with the disclosure herein is comparable to commercially available products.

### Example 5

The experiment is repeated in accordance with the steps in Example 2 up to the step of adjustment of the pH of the reactant solution mixture in the reaction tank to 9.5. In this Example, the reaction tank is then subjected to microwave radiation at a power of 3800 W for 10 minutes followed by at a power of 1100 W for 16 minutes. The product mixture is washed with water and filtered. The filtered product is dried at 250° C. for 8 hours.

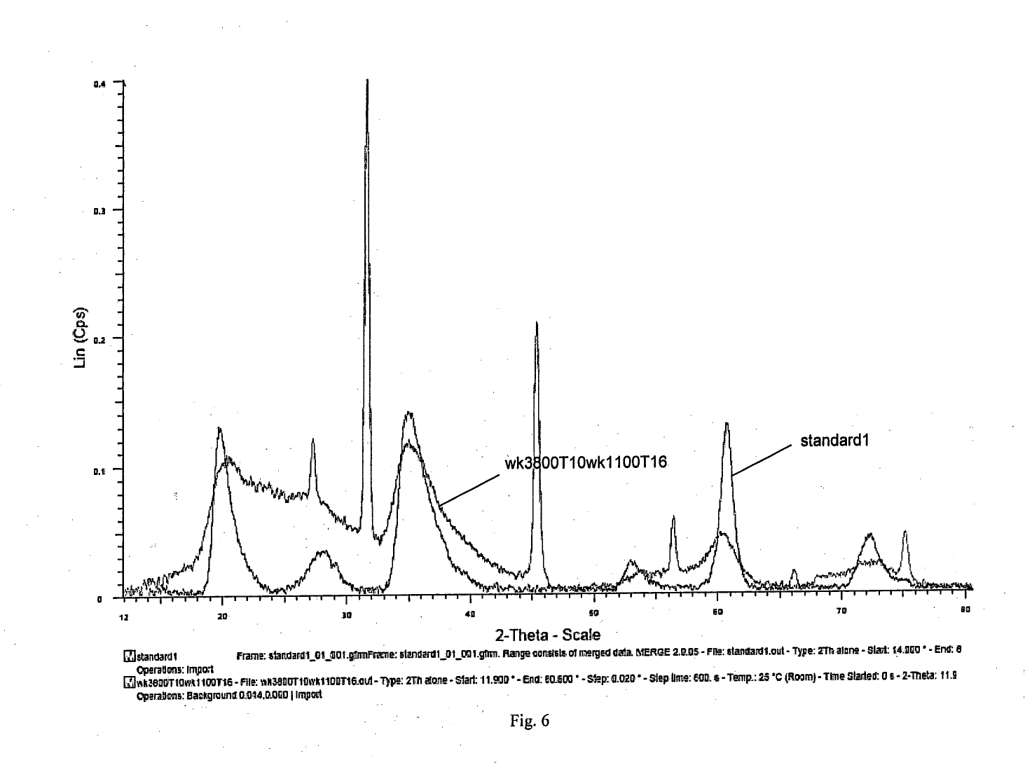

FIG. 6 shows the X-ray diffraction pattern of the experimental product (labeled as “wk3800T10wk1100T16”) obtained in accordance with the experimental protocol described above in comparison with a commercially available product, Laponite® (Southern Clay Particles, Inc., Tex.) (labeled. as “standard1”). As shown in FIG. 6, the X-ray diffraction pattern of the experimental product obtained is similar to that of Laponite®. Accordingly, it has been shown that the three dimensional atomic structure of the experimental product (synthetic clay particles) obtained in accordance with the disclosure herein is comparable to commercially available products.

### APPLICATIONS

It will be appreciated that the disclosed process is a continuous process.

It will be appreciated that the disclosed process does not involve the use of high pressure or high temperature. This effectively reduces capital and operating costs.

It will be appreciated that the disclosed process produces synthetic clay particles of uniform size, shape and composition.

It will be appreciated that the disclosed process requires less time for production of the synthetic clay particles. This is possible due to the use of a radiation source instead of conventional heating methods for the co-precipitation of the synthetic clay particles.

It will be appreciated that the disclosed process produces synthetic clay particles that are in a substantially pure state. Furthermore, the disclosed process does not require complicated purifying steps to obtain pure synthetic clay particles.

It will be appreciated that the disclosed process produces synthetic clay particles that have several commercial applications. The synthetic clay particles can be used as or in the manufacturing of a rheology modifier in aqueous solution, a film forming agent, a catalyst or base for catalyst, nanocomposites or energy storage nanocomposites, optic electronics, photovoltaic and organic light emitting diodes, and sensors such as humidity sensors or biosensors.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A process for synthesizing clay particles comprising the step of heating a reactant solution mixture of metal salt and a metal silicate using a radiation source under conditions to form said clay particles.

2. A process according to claim 1 comprising the step of selecting said metal silicate from the group consisting of lithium silicate, sodium silicate, potassium silicate, beryllium silicate, magnesium silicate and calcium silicate.

3. A process according to claim 1 comprising using a molar excess of metal silicate relative to said metal salt said reactant solution mixture.

4. A process according to claim 1 wherein said radiation source is a microwave radiation source.

5. A process according to claim 4, comprising the step of applying said microwaves at a power in the range of 30 W to 180 KW or 30 W to 1200 W.

6. A process according to claim 4, comprising the step of applying said microwaves with a frequency is in the range of 0.3 GHz to 300 GHz.

7. A process according to claim 4, comprising the step of applying said microwaves for a period of time in the range of 20 minutes to 2 hours.

8. A process according to claim 1 wherein said heating is undertaken under a substantially alkaline pH condition.

9. (canceled)

10. (canceled)

11. A process according to claim 8 comprising the step of adding a metal hydroxide solution to said reactant mixture to obtain said alkaline pH condition.

12. A process according to claim 1 wherein said metal of said metal salt is a multi-valent metal salt solution.

13. A process according to claim 1 wherein said metal of said metal salt is selected from the group consisting of alkali metals, alkaline earth metals, a metals of group IIIA, VIIB and VIII of the Periodic Table of Elements.

14. A process according to claim 13 wherein said metal of said metal salt is selected from the group consisting of sodium, potassium, lithium, magnesium, calcium, aluminium, iron, and manganese.

15. A process according to claim 13 wherein said anion of said metal salt is a halide.

16. (canceled)

17. A process according to claim 1 wherein said metal salt and said source of silicates are selected to synthesize the clay particles selected from the group consisting of chryolite, chlinochlore, kaolinite, nontronite, paragonite, phlogopite, pyrophyllite, smectite, talc, vermiculaite and mixtures thereof.

18. A process according to claim 17 wherein said smectite clay is selected from the group consisting of bentonite, beidellite, hectorite, montmorillonite, saponite, stevensite, and mixtures thereof.

19. A process according to claim 1 comprising the step of removing said clay particles from said reactant solution.

20. A process according to claims 19 comprising the step of drying said removed clay particles to substantially remove extraneous water therefrom.

21. A process according to claim 19 wherein said drying step is carried out at a temperature of about 250 degree C.

22. A process according to claim 19 wherein said drying step is carried out for about 8 hours.

23. A process according to claim 1, wherein the particle size of said clay particles is in the nano-meter range to the micrometer range.

24. (canceled)

25. (canceled)
